(19) United States
(12) Patent Application Publication
(10) Pub. No.: US 2007/0294131 A1
(43) Pub. Date: Dec. 20, 2007

(54) Method of compensation for content recommendations

(76) Inventors: Elias Roman, Douglas Manor, NY (US); Elliot Breece, Washington, DC (US); Joshua Boltuch, Oakland, CA (US); Lucas Hrabovsky, Glenshaw, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/446,080

(22) Filed: Jun. 2, 2006

(51) Int. Cl. G07G 1/14

(52) U.S. Cl. 705/14

(57) ABSTRACT

A system and method of dynamic compensation for providing content recommendations. When a content recommendation is received from a first user, a first value of the content may be determined at the time related to receipt of the recommendation. A second value of the content may be determined after a first predetermined time period and a third value may be determined that is based on a difference between the first and second values. The third value may be paid to the first user. The first and second values may be indicative of demand over different time periods. Thus, recommenders may be compensated according to the individual success of the content they recommend, as measured by the increase in valuation of the content from the time of recommendation to a later time when the content reaches a threshold valuation or increases a predetermined amount.

### FIELD OF THE INVENTION

The invention is directed generally to a system and method of compensation and more particularly to a system and method of compensation for content recommendations.

### BACKGROUND OF THE INVENTION

The amount of information and content available on the Internet continues to grow at an exponential rate. The increasing availability of broadband connections in homes and in the workplace enables more individuals to access and download a greater array of digital content (i.e., music, videos, books, podcasts, software, etc.). In addition, the Internet has evolved into a vast virtual social network, making it easier for consumers to explore and discover new content that is continuously being produced by individuals and organizations all over the world. For example, consumers may explore new content by sharing or exchanging it electronically with one another. Consumers may also reduce the uncertainty associated with purchasing new content by reading and/or posting online reviews that reflect their individual preferences and experiences. Thus, consumers may utilize the Internet's social network to facilitate the process of content discovery and validation.

In addition, content producers may use the Internet to bypass, or cut-out, traditional content distributors, which may arbitrarily filter the types of content that is made available to consumers. Thus, the Internet may give content producers a direct and cost-effective means for reaching consumers and may allow content producers to cultivate an audience by enabling them to make some or all of their content available electronically on the Internet. In addition, the Internet may promote content awareness among consumers via online reviews and/or recommendations provided by members of the online community, thereby helping content producers to commercialize their work.

Thus, consumer reviews may be advantageous to both consumers and producers of content. However, only a small portion of the total number of consumers typically participate in and/or contribute to the review process. This may be due to a lack of time, incentive, or both, on the part of consumers. As noted above, by sorting and flagging the best content, previous consumers may enable potential consumers to make informed purchase decisions regarding the vast array of available content. Therefore, a need exists for a system and method for encouraging participation by compensating consumers for providing content recommendations on the basis of the success and/or relevance of their recommendations.

### SUMMARY OF THE INVENTION

The described embodiments contemplate a system and method of compensation for content recommendations. In one embodiment, the method may include receiving a content recommendation from a first user, determining a first value of the content at a time related to receipt of the recommendation, determining a second value of the content after a first predetermined time period from receipt of the recommendation, calculating a third value that is based on a difference between the first value and the second value of the content, and paying the third value to the first user. The first value may be indicative of demand for the content over a time period prior to the recommendation and the second value may be indicative of demand for the content over the first predetermined time period.

The system may include an interface component for receiving a content recommendation from a first user of a plurality of users and a memory component for storing information associated with the content and the plurality of users. The system may also include a processing component for using the information to determine a first value of the content at a time related to receipt of the content recommendation, for determining a second value of the content after a first predetermined time period from receipt of the recommendation, and for determining a third value that is based on the difference between the first and second values. The third value may be paid to the first user.

In an alternative embodiment, the method may include assigning a recommendation unit to a user and allowing the user to assign the recommendation unit to selected content. The selected content may have a first value that is a function of demand over a first time period prior to assignment of the recommendation unit. The method may also include varying the value of the selected content over time as a function of demand and compensating the user at the end of a predetermined time period by a second value. The second value may be based on a difference between the first value and a third value of the content at the end of the predetermined time period. The third value may be a function of demand for the selected content over the predetermined time period.

The system may include a first processing component for assigning a recommendation unit to a user, a user interface component for allowing the user to assign the recommendation unit to selected content, a second processing component for varying the value of the selected content over time as a function of demand, and a third processing component for compensating the user at the end of a predetermined time period. The user may be compensated based on a difference between a first value and a second value of the content. The first value may be a function of demand over a first time period prior to assignment of the recommendation unit and the second value may be a function of demand over the predetermined time period.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the invention is not limited to the specific methods and instrumentalities disclosed. In the drawings:

FIGS. 1A and 1B are diagrams illustrating an example system in which aspects of the invention may be implemented;

FIG. 2 is a flow diagram illustrating an example method for providing compensation for a content recommendation;

FIG. 3 is a flow diagram illustrating an example method for receiving compensation for providing a content recommendation; and

FIG. 4 is a flow diagram illustrating an example method for periodically updating content pricing based on demand for the content.

### DETAILED DESCRIPTION OF ILLUSTRATIVE EMBODIMENTS

The inventive subject matter is described with specificity to meet statutory requirements. However, the description of the preferred embodiments itself is not intended to limit the scope of this patent. Moreover, although the term “step” may be used herein to connote different elements of methods employed, the term should not be interpreted as requiring any particular order among or between various steps herein disclosed unless otherwise stated.

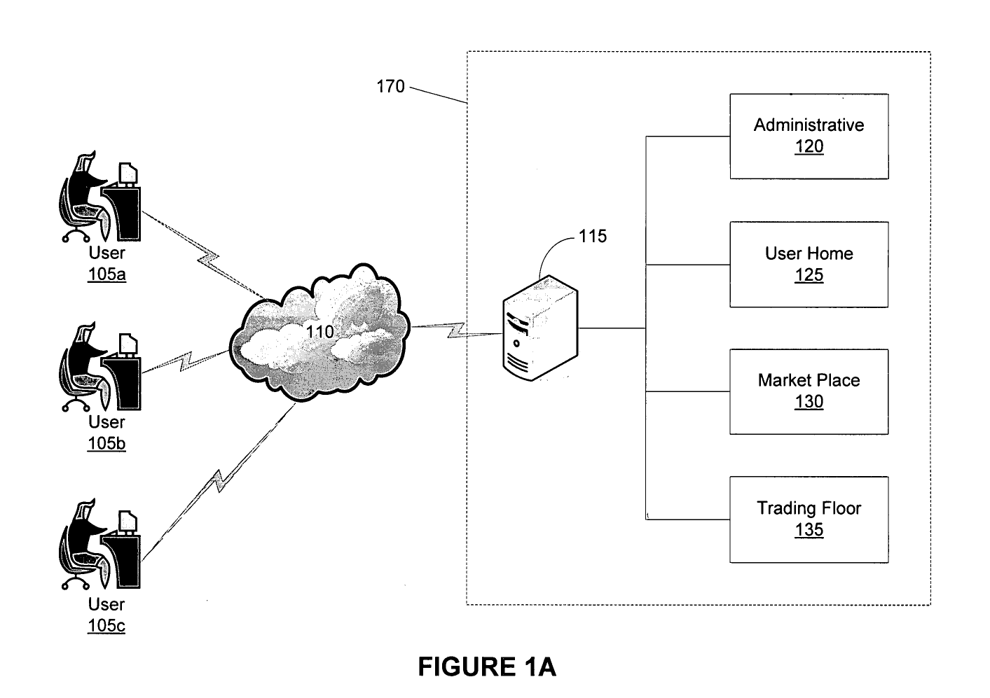

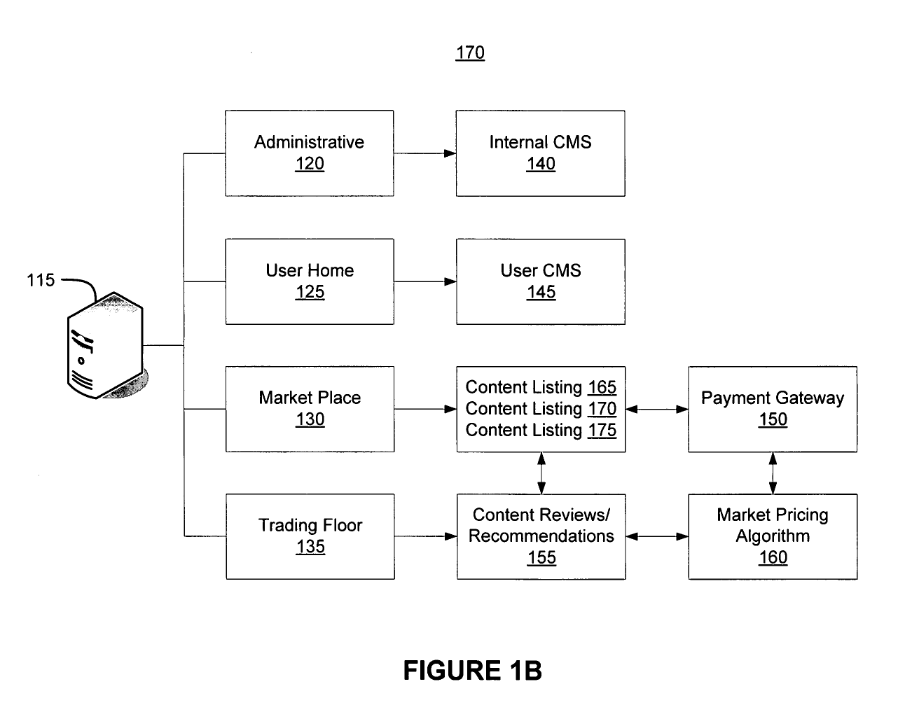

FIGS. 1A and 1B illustrate an example system in which the present invention may be implemented. Of course, actual network and database environments may be arranged in a variety of configurations; however, the example environment shown here provides a framework for understanding the type of environment in which an embodiment may operate.

As shown in FIG. 1A, the example system may include users 105a, 105b, 105c and website 170, though it will be appreciated that an embodiment may include any number of users and/or websites. Users 105a, 105b, 105c may be any individual or entity that views, listens to, purchases, sells, and/or produces content. Examples of content may include music, videos, books, podcasts, software, pictures, and the like. Users 105a, 105b, 105c may communicate with website 170 using general purpose and/or special purpose computers (not shown), such as personal computers (PCs), personal digital assistants (PDAs), cellular telephones, and the like. Such computers may run commercially available web browser and/or e-mail applications, which may allow users 105a, 105b, 105c to view and receive information from website 170. Users 105a, 105b, 105c may access website 170 by way of communication network 110, which may include an intranet, the Internet, a local area network (LAN), a wide area network (WAN), a public switched telephone network (PSTN), a cellular network, a Voice over Internet Protocol (VOIP) Network, and the like.

Website 170 may include server computer 115, which may be accessible to users 105a, 105b, 105c via communications network 110. Server computer 115 may enable users 105a, 105b, 105c to access various Internet domains, or webpages, associated with website 170. For example, as shown in FIG. 1A, users 105a, 105b, 105c may access administrative webpage 120, user home webpage 125, market place webpage 130, and/or trading floor webpage 135. It will be appreciated that website 170 may include any number of webpages and may be implemented using multiple server computers, which may be geographically remote from one another. In addition, website 170 may also include one or more databases (not shown) and other back-end components (not shown) to generate and/or format webpages 120, 125, 130 and 135. Server computer 115 may include one or more web server applications (not shown) and database server system software (not shown) to generate webpages 120, 125, 130 and 135 and/or store information in response to actions by users 105a, 105b, 105c.

As shown in FIG. 1B, website 170 may include or aggregate various types of information, which may be accessible via webpages 120, 125, 130 and 135. For example, administrative webpage 120 may include internal content management system (CMS) 140, which may enable website 170 to aggregate user information (e.g., purchase history, personal preferences, etc.). Such information may be sold to third parties and/or be used to update website 170 to be more relevant to users 105a, 105b, 105c. In addition, internal CMS 140 may enable website 170 to enforce community policies and standards by removing objectionable content, monitor web traffic and bandwidth, and adjust server 115 settings as necessary.

User home webpage 125 may include user CMS 145, which may enable users 105a, 105b, 105c to update their respective personal profiles on website 170. Thus, users 105a, 105b, 105c may be able to enter and/or update personal information that may be made public or private on website 170. For example, users 105a, 105b, 105c may enter and/or update information regarding their favorite music or movies. Such personal information may be made publicly available to on website 170. Users 105a, 105b, 105c may enter and/or update their personal identifiers (e.g., address, date of birth, etc.) or payment information (e.g., credit card information). This type of information may be inaccessible on website 170. User home webpage 125 may also allow users 105a, 105b, 105c to view and monitor their library of previously purchased content. For example, users 105a, 105b, 105c may view previously purchased songs as well as a price history of the song and/or activity of the artist. User home webpage 125 may also enable content producers (e.g., musicians, authors, publishers, etc.) to publish, or upload, content to website 170. User home webpage 125 may also enable content producers to assign identifying tags (e.g., title, description, etc.) to each respective content, and manage sales information regarding payment frequency and other payment details (e.g., form of payment, direct deposit options, etc.). As will be explained below, the uploaded content may have a predetermined initial value (e.g., zero cents), and thereafter the value of the uploaded content may be varied by a dynamic pricing algorithm that sets a price based on demand for the content.

As shown in FIG. 1B, market place webpage 130 may contain content listings 165, 170, 175, though it will be appreciated that market place webpage 130 may contain any number of content listings while remaining consistent with an embodiment. Content listing 165, 170, 175 may include various types of content, such as music, videos, books, podcasts, software, and the like. Market place webpage 130 may also contain information regarding content listings 165, 170, 175, such as descriptions, editorial reviews, consumer reviews, consumer recommendations, summaries, interviews, promotions, pictures, and the like. Content listings 165, 170, 175 may be accessible via links on market place webpage 130 to one or more electronic files, which may consist of any suitable file format, such as a WINDOWS® media audio (WMA) file, a WINDOWS® media video (WMV) file, a MPEG audio layer 3 (MP3) file, a portable document format (PDF) file, and the like.

As indicated above, content listings 165, 170, 175 may be uploaded to website 170 by content producers. Content listings 165, 170, 175 may be uploaded for free or for a fee. Thus, market place webpage 130 may enable users 105a, 105b, 105c to upload, research, view, listen to, purchase and/or download content listings 165, 170, 175. Purchases may be processed by way of payment gateway 150, which may enable users 105a, 105b, 105c to purchase content listings 165, 170, 175 via any suitable form of payment, such as by way of debit or credit card.

Prices for content listings 165, 170, 175 on market place webpage 130 may be fixed or may be dynamic. A dynamic pricing scheme may include continuously and/or periodically updating the prices of content listings 165, 170, 175 to reflect demand for each respective content listing. More specifically, server 115 may include software for continuously and/or periodically updating the prices for content listings 165, 170, 175 via market pricing algorithm 160, which may utilize one or more variables to establish a market price for content listings 165, 170, 175.

Server 115 may update the price of content listings 165, 170, 175 after a predetermined time period (e.g., every 15 minutes) by querying one or more databases (not shown) that store information associated with content listings 165, 170, 175 and users 105a, 105b, 105c. For example, the database may store the number of active users of website 170, which may include users 105a, 105b, 105c. The number of active users may represent the total number of users who have purchased and/or downloaded content over a predetermined time period, such as over the past three months, for example. The number of active users may also represent the number of users that have visited website 170 over a predetermined time period or who are currently registered with website 170. It will be appreciated that the number of active users may be any number that is indicative of the size of the online community of website 170. The database may also store a number of purchases and/or price history of each respective content listing over a predetermined time period. Server 115 may retrieve and process the information from the database and update the prices for content listings 165, 170, 175 via market pricing algorithm 160.

Market pricing algorithm 160 may utilize one or more variables to determine a price that reflects market demand for content listings 165, 170, 175. In one embodiment, market pricing algorithm 160 may use a listing penetration to calculate a new price for content listing 165, which may be a song, for example. The listing penetration may equal a percentage of active users that have purchased the song over a predetermined time period (e.g., 96 hours) and, therefore, may be indicative of the song's popularity. The listing penetration may equal the new price and may be calculated as follows:

$$\begin{matrix}New Price \\ ( in dollars )\end{matrix} = \frac{\begin{matrix}Number of Purchases Over \\ Predetermined Time Period\end{matrix}}{Number of Active Users}$$

### EXAMPLE ALGORITHM 1

Thus, using example algorithm 1, the listing penetration for the song would be 0.10, or 10%, and the price of the song may equal $0.10, or 10 cents, if there are 1,000 purchases of the song over a 96-hour time period and website 170 has 10,000 active users. It will be appreciated that market pricing algorithm 160 may also use a normalizing factor in order to cause the new price to fall within a desired price range. For example, a normalizing factor of 5 may be added to, subtracted from, and/or multiplied by the listing penetration value to arrive at a new price of $0.15, $0.05, and $0.50, respectively, though any numerical factor may be used while remaining consistent with an embodiment of the invention.

In another embodiment, market pricing algorithm 160 may use a member population (MP) factor, in addition to listing penetration, to update the price of content listings 165, 170, 175. Market pricing algorithm 160 may use the MP factor to adjust the price such that a listing penetration of 10% with 1,000 active users, for example, results in a lower price than a listing penetration of 10% with 100,000 active users. Thus, the MP factor allows market pricing algorithm 160 to compensate for the fact that a given listing penetration may be more indicative of success if it is over a larger base of active users. More specifically, the MP factor may be configured to cause the price to decrease as the number of active users decreases and the price to increase as the number of active users increases. The MP factor may be a predetermined numerical value and may be assigned to a predetermined quantity or range of active users. The MP factor may be added to or subtracted from the listing penetration. In addition, the MP factor may be a multiplier or divisor. Thus, in one example, market pricing algorithm 160 may be defined as follows:

New Price (in dollars)=(Listing Penetration×10)−MP Factor

### EXAMPLE ALGORITHM 2

The MP factor may be assigned according to the following ranges of active users:

TABLE 1

| Number of Active Users | MP Factor |
|---|---|
| 0–10,000 | 0.07 |
| 10,001–20,000 | 0.06 |
| 20,001–30,000 | 0.05 |
| 30,001–40,000 | 0.04 |
| 40,0001–50,000 | 0.03 |
| 50,001–60,000 | 0.02 |
| 60,001–70,000 | 0.01 |
| 70,001 and up | 0 |

Thus, continuing with the example above, content listing 165 may be a song and may have a listing penetration of 0.10, or 10% (e.g., 1,000 purchases over 96-hour period divided by 10,000 active users). Based on table 1, the MP factor may be 0.07 if there are 10,000 active users or less. Accordingly, using example algorithm 2, the new price for the song may equal $0.93, or 93 cents (i.e., (0.10×10)−0.07). Based on table 1, if the song has a listing penetration of 10% with 100,000 active users, the MP factor may be zero and the new price may equal $1.00, or 100 cents (i.e., (0.10×100)−0). Tables 2 and 3, below, illustrate how the price of the song may be affected, using example algorithm 2 and the MP values in table 1, via changes in listing penetration and/or the number of active users:

TABLE 2

| Active | Number of | Listing | MP | |
|---|---|---|---|---|
| Users | Purchases | Penetration | Factor | Price |
| 25,000 | 250 | 1% | 0.05 | $0.05 |
| 25,000 | 500 | 2% | 0.05 | $0.15 |
| 25,000 | 750 | 3% | 0.05 | $0.25 |
| 25,000 | 1,000 | 4% | 0.05 | $0.25 |
| 25,000 | 1,250 | 5% | 0.05 | $0.35 |
| 25,000 | 1,500 | 6% | 0.05 | $0.45 |
| 25,000 | 1,750 | 7% | 0.05 | $0.55 |
| 25,000 | 2,000 | 8% | 0.05 | $0.65 |
| 25,000 | 2,250 | 9% | 0.05 | $0.75 |
| 25,000 | 2,500 | 10% | 0.05 | $0.85 |

TABLE 3

| Active | Number of | Listing | MP | |
|---|---|---|---|---|
| Users | Purchases | Penetration | Factor | Price |
| 75,000 | 750 | 1% | 0 | $0.10 |
| 75,000 | 1,500 | 2% | 0 | $0.20 |
| 75,000 | 2,250 | 3% | 0 | $0.30 |
| 75,000 | 3,000 | 4% | 0 | $0.40 |
| 75,000 | 3,750 | 5% | 0 | $0.50 |
| 75,000 | 4,500 | 6% | 0 | $0.60 |
| 75,000 | 5,250 | 7% | 0 | $0.70 |
| 75,000 | 6,000 | 8% | 0 | $0.80 |
| 75,000 | 6,750 | 9% | 0 | $0.90 |
| 75,000 | 7,500 | 10% | 0 | $1.00 |

Thus, as illustrated in Tables 2 and 3, a larger number of active users may cause the price of the song to remain the same or increase despite a constant, or even declining, listing penetration. Alternatively, a smaller number of active users may cause the price of the song to remain the same or decrease despite a constant, or even increasing, listing penetration.

After server 115 determines the new price of the song, the new price may be added to the song's price history and saved to the database. The price of the song may be updated on market place webpage 130 and the process may be repeated after a predetermined time period, such as every 15 minutes, for example.

Although the number of active users and the number of purchases were determined above using a trailing 3-month and 96-hour time period, respectively, it will be appreciated that any suitable time period may be employed while remaining consistent with an embodiment. It will further be appreciated that a MP factor having any suitable value maybe assigned to any predetermined quantity or range of active users such that the price of content listings 165, 170, 175 may be higher when there is a larger base of active users and lower when there is a smaller base of active users.

As shown in FIG. 1B, website 170 may also include trading floor webpage 135, which may be an online platform where users 105a, 105b, 105c can recommend, and/or “invest,” in content listings 165, 170, 175. Server 115 may include software for allocating or assigning recommendation units to users 105a, 105b, 105c. The RECs may be allocated to users 105a, 105b, 105c in any suitable manner. By way of example, and not limitation, a REC may be given to users 105a, 105b, 105c for each dollar that users 105a, 105b, 105c deposit into an account (not shown) associated with website 170. The funds may be used to pay for each REC or may be used to purchase content listings 165, 170, 175 on market place webpage 130 and/or to purchase goods and services from other merchants associated with website 170. Each REC may represent a numerical unit and may include a textual review. In addition, each REC may be valid for an unlimited or a limited duration (e.g., must be invested within a certain time period) and/or may only be used for a limited number of content listings (e.g., 1 REC per listing).

Server 115 may also include software for enabling users 105, 105b, 105c to invest each REC in content listing 165, 170, 175 via trading floor webpage 135, though it will be appreciated that RECs may be invested via any suitable webpage, such as user home webpage 125, for example. Market place webpage 130 may include each respective content listing along with the total number RECs that have been invested by users 105a, 105b, 105c. Users 105a, 105b, 105c may also search the content listings available on market place webpage 130 on the basis of the number RECs each listing has received. If, for example, content listing 165 has received the most RECs, users 105a, 105b, 105c may be inclined to purchase and/or download content listing 165 because such content may be viewed as having a higher quality. Thus, by searching the content listings according to RECs, users 105a, 105b, 105c may research and discover the best content more quickly and efficiently.

As an incentive for users 105a, 105b, 105c to review and recommend content listings 165, 170, 175, server 115 may include software that compensates users 105a, 105b, 105c based on the success and/or relevance of their content recommendation, thereby enabling users 105a, 105b, 105c to profit from the success/popularity of the recommended content. For example, as noted above, content listing 165 may be a particular song. The price of the song may be continuously and/or periodically updated to reflect changes in market demand. Thus, the price of the song may fluctuate over time as a result of the purchase activity of users 105a, 105b, 105c. If, for example, user 105a invests a REC in the song and the price of the song subsequently increases, user 105a may be compensated based on the difference between the price of the song at the time of investment and its subsequent higher price. The price of the song at the time of investment may be referred to as user 105a's cost basis, though it will be appreciated that user 105a may not necessarily incur any financial risk if user 105a does not incur any costs in acquiring the REC.

In another example, the song may have been uploaded recently and, therefore, may not have been available long enough to generate purchase activity. Thus, the song may initially be downloaded by users 105, 105b, 105c for free. In addition, the song may initially be made available to users 105a, 105b, 105c for free for a predetermined period of time as a way to encourage users 105a, 105b, 105c to download the song in advance of any recommendations regarding the quality of the song. If purchase activity for the song increases, the song's price may increase by way of market pricing algorithm 160. User 105a may decide to invest a REC when the song reaches $0.22, though it will be appreciated that user 105a is free to invest at any price point. Thus, in this example, user 105a's cost basis may be $0.22. If purchase activity for the song continues to increase, user 105a may be compensated when the price of the song equals or exceeds a predetermined threshold. For example, user 105a may receive one-half of the difference between $0.22 and a price threshold of $0.45, $0.70, or $0.98. In other words, user 105a may receive $0.23/2 if the song reaches $0.45 (i.e., $0.45 minus $0.22 divided by 2), $0.48/2 if the song reaches $0.70 (i.e., $0.70 minus $0.22 divided by 2), or $0.76/2 if the song hits $0.98 (i.e., $0.98 minus $0.22 divided by 2). As a means to encourage users 105a, 105b, 105c to research and recommend content listings as early as possible, users 105a, 105b, 105c may collect the full spread if they invest when the content listing is at its initial price or is otherwise available for free. It will be appreciated that the threshold values and compensation formula noted above illustrate just one embodiment. In other embodiments, the price threshold may be set at any suitable value and the compensation may equal the price differential or any fraction or multiple thereof. Rewarding users for the early recommendation of exceptional content encourages users to spend more time exploring the listed content, which is particularly important for raising revenue through advertising. Also, allowing the users to identify the best content optimizes the user experience by making the best content easy to find in accordance with the collective preference of the community reviewing the content.

Continuing with the above example, it will further be appreciated that the song may have a series of price thresholds, such as $0.45, $0.70 and $0.98. Thus, user 105a may be compensated each time the price of the song equals or exceeds a respective threshold value. Accordingly, user 105a's cost basis may be increased, or stepped-up, as the price of content listing 165 equals or exceeds each respective threshold value. For example, user 105a may receive $0.23/2 if the song reaches at least $0.45 (i.e., $0.45 minus $0.22 divided by 2) and user 105a's cost basis may be adjusted to $0.45. User 105a may receive an additional $0.25/2 if the song reaches at least $0.70 (i.e., $0.70 minus $0.45 divided by 2) and user 105a's cost basis may again be adjusted to $0.70. This process may be repeated at each price threshold and/or until the song reaches a predetermined maximum price.

From the foregoing discussion, it will be apparent that user 105a may be compensated based on the song's appeal to users 105b, 105c, which may or may not coincide with the preferences of user 105a. In other words, user 105a may invest in the song based on a subjective preference and/or based on an objective preference of users 105b, 105c, as perceived by user 105a. Thus, website 170, by way of a dynamic method of compensation, may develop an assessment of a collective perception of a collective preference. This may enable the market on website 170 to become representative of its users' preferences with a smaller critical mass of reviews. In addition, the dynamic method of compensation may incentivize users 105a, 105b, 105c to sort through a mass of content and recommend, or “flag,” the content that users 105a, 105b, 105c believe to be most relevant to other users based on perceived preconditions relating to both preference of the content in question and the usage of website 170.

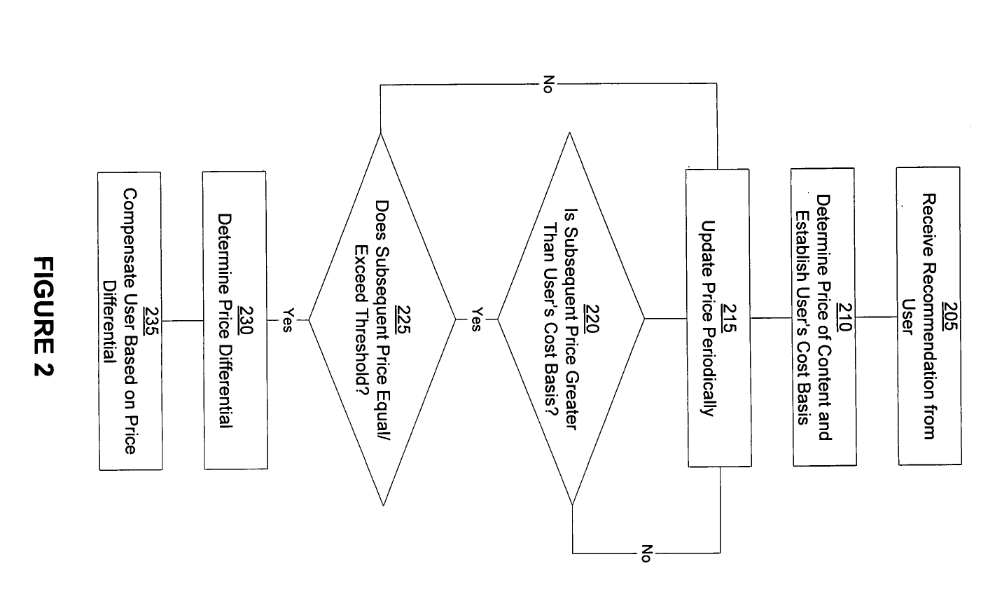

FIG. 2 is a flow diagram illustrating an example method for providing compensation for content recommendations. At 205, website 170 may receive a recommendation unit, or REC, from user 105a for content listing 165 via trading floor webpage 135, or other suitable means, such as email. The REC may represent a numerical unit and may include a textual review of content listing 165. At 210, the price of content listing 165 may be determined using market pricing algorithm 160. The price may reflect demand for content listing 165 at about the time the REC was received and may also correspond to user 105a's cost basis. At 215, the price of content listing 165 may be updated periodically. For example, the price of content listing 165 may be updated every 15 minutes. It will be appreciated that the price may be updated at any suitable time interval.

At 220, it may be determined whether the most recent price of content listing 165 is greater than user 105a's cost basis. For example, if user 105a has a cost basis of $0.22 and the most recent price of content listing is $0.30, the process may proceed to 225. Otherwise, the process may return to 215, wherein the price of content listing 165 may continue to be periodically updated via market algorithm 160. At 225, it may be determined whether the most recent price of content listing 165 equals and/or exceeds a predetermined price threshold. For example, if the price threshold is set at $0.45 and the most recent price of content listing 165 is $0.30, the process may return to 215, wherein the price of content listing 165 may continue to be periodically updated via market algorithm 160. If the most recent price of content listing 165 is at least $0.45, the process may proceed to 230. It will be appreciated that the price threshold may be set at any suitable value.

At 230, the difference between user 105a's cost basis and the most recent price of content listing 165 may be determined. Thus, if the most recent price of content listing 165 is $0.45 and the cost basis of user 105a is $0.22, the price differential may be equal to $0.23 ($0.45 minus $0.22). At 235, user 105a may be compensated based on the price differential. For example, user 105a may receive credits and/or funds with a value less than, equal to, or greater than the price differential. More specifically, in one embodiment, user 105a may receive credits or funds representative of one-half the price differential (e.g., $0.23/2). In another embodiment, user 105a may receive credits or funds representative of the full value of the price differential (e.g., $0.23). In yet another embodiment, user 105a may receive credit or funds representative of a multiple of the price differential (e.g., 2×$0.23).

As noted above, content listing 165 may have a series of price thresholds, such as $0.45, $0.70 and $0.98 cents, for example. Thus, user 105a may be compensated each time the price of content listing 165 equals or exceeds a respective threshold value. In addition, user 105a's cost basis may be increased, or stepped-up, as the price of content listing 165 equals or exceeds each respective threshold. In other words, user 105a's cost basis may increase from $0.22 to $0.45 when the price of content listing 165 reaches at least $0.45 and may increase from $0.45 to $0.70 when the price of content listing 165 reaches at least $0.70, and so on.

The credits or funds may be credited/deposited to an account that is held by user 105a and that is associated with website 170. The funds may be used to purchase other content listings (e.g., content listings 170, 175) on website 170 and/or may be used to purchase goods and services from other merchants associated with website 170.

In another embodiment, user 105a may be assigned a recommendation unit, or REC, from website 170. The REC may be assigned to user 105a based on an amount of funds deposited and/or held in an account associated with website 170. User 105a may then assign the REC to selected content on website 170. The REC may be assigned on the basis of user 105a's subjective preference and/or on the basis of the objective preference of users 105b, 105c. The price of the selected content may be a function of demand over a time period prior to assignment of the recommendation unit. For example, the price of the selected content at the time a REC is assigned by user 105a may be set by market pricing algorithm 160. The price of the selected content may be continuously and/or periodically updated via market pricing algorithm 160. User 105a may be compensated at the end of a predetermined time period based on a difference between the value of the content at the time the REC was assigned and the value of the selected content at the end of the predetermined time period. The above method may be implemented via server 115. For example, server 115 may include a user interface that allows user 105a to assign the REC to selected content on website 170. In addition, server 115 may include one or more processing components for assigning the REC to user 105a, varying the price of the selected content over time as a function of demand for the content, and compensating the user 105a at the end of the predetermined time period.

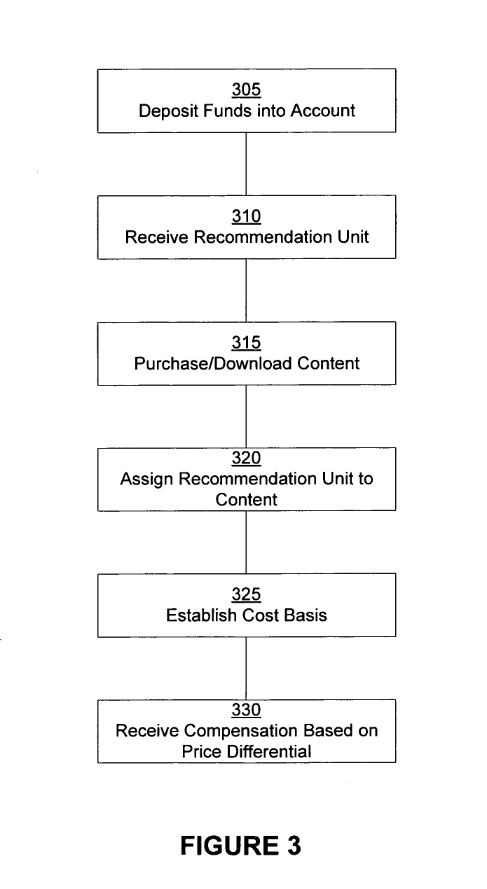

FIG. 3 is a flow diagram illustrating an example method for receiving compensation for providing a content recommendation. At 305, user 105a may deposit funds into an account associated with website 170. At 310, user 105a may receive one or more recommendation units (RECs) from website 170. The RECs may be distributed in any suitable manner, such as based on the amount of funds deposited by user 105a (e.g., 1 REC for each deposited dollar). The RECs may be used to invest in content listings 165, 170, 175. At 315, user 105a may use the funds to purchase and download content listing 165, for example, from website 170. User 105a may also use the funds to purchase goods and services from other merchants associated with website 170. At 320, user 105a may invest one or more RECs in content listing 165. User 105a may invest the REC in content listing 165 based on user 105a's own subjective preferences and/or based on the objective preferences of users 105b, 105c, as perceived by user 105a. User 105a may have a cost basis that equals the price of content listing 165 at the time of investment. At 325, user 105a may receive compensation based on a differential between user 105a's cost basis and the most recent price of content listing 165. For example, user 105a may receive compensation based on the difference between user 105a's costs basis and a price of content listing 165 that equals or exceeds at predetermined price threshold value. The compensation may be equal to the differential or may be any fraction or multiple of thereof. The compensation may be in the form of funds and/or credits that are deposited into an account associated with website 170. User 105a may use such “gains” to purchase additional content listings from website 170 and/or goods and services from other merchants associated with website 170.

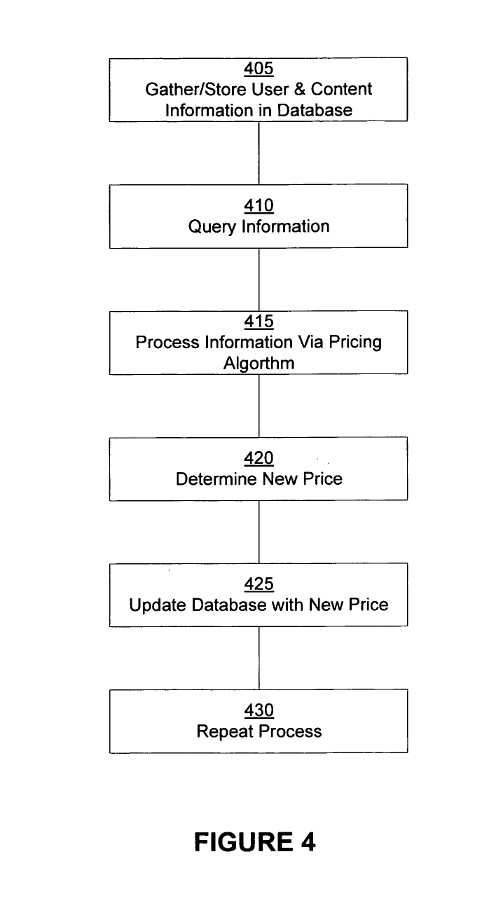

FIG. 4 is a flow diagram illustrating an example method for periodically updating content pricing based on market demand. At 405, server 115 may store information pertaining to users 105a, 105b, 105c and content listings 165, 170, 175 in a database. Such information may include a total number of purchases and/or views of content listings 165, 170, 175 over a predetermined period. The information may also include the price history of content listings 165, 170, 175 and a total number of active users of website 170. At 410, server 115 may query the database at a predetermined time interval. For example, the database may be queried every 15 minutes to update the prices for content listings 165, 170, 175 to reflect changes in demand. At 415 and 420, server 115 may process the queried information and determine a new price for content listings 165, 170, 175 via market pricing algorithm 160, which may utilize such variables as the listing penetration and the MP factor. At 425, the database may be updated with the new prices for content listings 165, 170, 175. At 430, the process may be repeated after each predetermined interval.

Those skilled in the art will appreciate that the number of recommendations (REC units) on a song may be used by content providers (e.g., bands) as another measure of popularity in addition to the fluctuating prices of their songs. The “market” activity of recommending songs will thus indirectly affect the song prices as people see that other fans like a given song. Moreover, the inclusion of recommendations (REC units) in the music market will serve at least five useful purposes:
1. REC units are an investment mechanism by which members may earn free music or merchandise.
2. REC units provide the ability to reward loyal (and potentially loyal) customers for spending more time on a music (or other content) site, and exploring for more music or other content.
3. REC units provide users with a dynamic list of music recommended by friends or others in the relevant community, thus facilitating highly effective word-of-mouth marketing.
4. REC units provide new artists (content providers) with another effective form of validation and marketing.
5. Demand-based pricing in tandem with community recommendations in the form of REC units fosters a two-way market that is more accessible for artists and more relevant to users.

Computer readable media can be any available media that can be accessed by a computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by a computer. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the appended claims.

What is claimed:

1. A method for providing compensation for a content recommendation, comprising:
receiving the content recommendation from a first user;
determining a first value of the content at the time related to receipt of the recommendation;
determining a second value of the content after a first predetermined time period from receipt of the recommendation;
determining a third value that is based on a difference between the first value and the second value; and
paying the third value to the first user.

2. The method of claim 1, wherein the content comprises an electronic file that can be downloaded from a website on the Internet.

3. The method of claim 2, wherein the content further comprises at least one of a song, a video, a book, a podcast, a picture, and software.

4. The method of claim 1, further comprising receiving the content from a content producer.

5. The method of claim 4, wherein the content is uploaded by the content producer to a website on the Internet.

6. The method of claim 1, wherein the recommendation comprises a recommendation unit.

7. The method of clam 6, wherein the recommendation unit is distributed to the first user based on an amount of funds deposited into an account.

8. The method of claim 6, wherein the recommendation unit can be used at least once by the first user.

9. The method of claim 1, wherein the recommendation comprises a textual review of the content by the first user.

10. The method of claim 1, wherein the recommendation is indicative of a subjective preference of the first user.

11. The method of claim 1, wherein the recommendation is indicative of an objective preference of a second user, as perceived by the first user.

12. The method of claim 1, wherein the recommendation is received electronically.

13. The method of claim 1, wherein the third value is paid to the first user if the second value is greater than the first value.

14. The method of claim 1, wherein the third value is paid to the first user if the second value is at least equal to a predetermined threshold value.

15. The method of claim 1, wherein the third value is substantially equal to the difference between the first value and the second value.

16. The method of claim 1, wherein the third value is less than the difference between the first value and the second value.

17. The method of claim 1, wherein the third value is greater than the difference between the first value and the second value.

18. The method of claim 1, wherein the third value is credited to an account held by the first user.

19. The method of claim 1, wherein the first value is indicative of demand for the content over a time period prior to the recommendation, and wherein the second value is indicative of demand for the content over the first predetermined time period.

20. The method of claim 1, wherein the first value and the second value are based on a listing penetration of the content, wherein the listing penetration comprises a ratio of a number of purchases of the content to a number of active users.

21. The method of claim 20, wherein the number of purchases is determined over a second predetermined time period and the number of active users is determined over a third predetermined time period.

22. The method of claim 20, wherein the first value and the second value are further based on a member population factor, wherein the member population factor comprises a predetermined numerical value that is associated with the number of active users.

23. The method of claim 22, wherein the first value and the second value are substantially equal to the listing penetration multiplied by a normalization factor, minus the member population factor.

24. The method of claim 22, wherein the first value and the second value are substantially equal to the listing penetration multiplied by a normalization factor, plus the member population factor.

25. The method of claim 22, wherein the first value and the second value are substantially equal to the listing penetration multiplied by a normalization factor and by the member population factor.

26. The method of claim 22, wherein the first value and the second value are substantially equal to the listing penetration multiplied by a normalization factor, divided by the member population factor.

27. A system for providing compensation for a content recommendation, comprising:
an interface component for receiving the content recommendation from a first user of a plurality of users;
a memory component for storing information associated with the content and the plurality of users; and
a processing component for using the information to determine a first value of the content at the time related to receipt of the content recommendation, for determining a second value of the content after a first predetermined time period from receipt of the recommendation, and for determining a third value that is based on a difference between the first and second values,
wherein the third value is to be paid to the first user.

28. The system of claim 27, wherein the content comprises digital media.

29. The system of claim 27, wherein the first value is indicative of demand for the content over a time period prior to the recommendation, and wherein the second value is indicative of demand for the content over the first predetermined time period.

30. The system of claim 27, wherein the first value and the second value are based on a listing penetration of the content, wherein the listing penetration comprises a ratio of a number of purchases of the content to a number of active users.

31. The system of claim 30, wherein the first value and the second value are further based on a member population factor, wherein the member population factor comprises a numerical value for adjusting each respective first value and second value based on the number of active users.

32. The system of claim 27, wherein the processing component pays the third value to the first user if the second value is at least equal to a predetermined threshold value.

33. The system of claim 27, further comprising an account held by the first user, wherein the third value is credited to the account.

34. The system of claim 27, wherein the information comprises at least one of a number of content views, a number of content purchases, a history of content values and a number of active users.

35. The system of claim 27, wherein the interface component comprises a website accessible via a communications network.

36. The system of claim 35, wherein the communications network comprises at least one of an intranet, the Internet, a local area network (LAN), a wide area network (WAN), a public switched telephone network (PSTN), a cellular network, a Voice over Internet Protocol (VoIP) Network.

37. A method for providing compensation for a content recommendation, comprising:
assigning a recommendation unit to a first user;
allowing the first user to assign the recommendation unit to selected content, wherein the content has a first value that is a function of demand for the content over a first time period prior to assignment of the recommendation unit;
varying the value of the selected content over time as a function of demand for the content; and
compensating the first user at the end of a predetermined time period by a second value that is based on a difference between the first value of the content and a third value of the content at the end of the predetermined time period, wherein the third value is a function of demand for the selected content over the predetermined time period.

38. The method of claim 37, wherein the recommendation unit is assigned to the first user upon the user depositing a predetermined amount of funds into an account.

39. The method of claim 37, wherein the recommendation unit is assigned by the first user on the basis of at least one of a subjective preference of the first user for the selected content and an objective preference of a second user for the selected content.

40. A computer system for providing compensation for a content recommendation, comprising:
a first processing component for assigning a recommendation unit to a first user;
a user interface component for allowing the first user to assign the recommendation unit to selected content, wherein the content has a first value that is a function of demand for the content over a first time period prior to assignment of the recommendation unit;
a second processing component for varying the value of the selected content over time as a function of demand for the content; and
a third processing component for compensating the first user at the end of a predetermined time period by a second value that is based on a difference between the first value of the content and a third value of the content at the end of the predetermined time period, wherein the third value is a function of demand for the selected content over the predetermined time period.

41. A computer-readable medium having computer-executable instructions for performing:
receiving a content recommendation from a first user;
determining a first value of the content at the time related to receipt of the recommendation, wherein the first value is indicative of demand for the content over a time period prior to the recommendation;
determining a second value of the content after a first predetermined time period from receipt of the recommendation, wherein the second value is indicative of demand for the content over the first predetermined time period;
determining a third value that is based on a difference between the first value and the second value; and
crediting the third value to the first user.

42. The computer-readable medium of claim 41, having further computer-executable instructions for receiving the content from a content producer, wherein the content comprises at least one of a song, a video, a book, a podcast, a picture, and software.

43. The computer-readable medium of claim 41, wherein the recommendation comprises a recommendation unit that is assigned to the first user based on an amount of funds deposited into an account.

44. The computer-readable medium of claim 41, wherein the recommendation is indicative of at least one of a subjective preference of the first user and an objective preference of a second user, as perceived by the first user.

45. The computer-readable medium of claim 41, wherein the third value is credited to the first user if the second value is at least equal to a predetermined threshold value.

46. The computer-readable medium of claim 41, wherein the third value is credited to an account held by the first user.

47. The computer-readable medium of claim 41, having further computer-executable instructions for determining the first value and the second value based on a listing penetration of the content, wherein the listing penetration comprises a ratio of a number of purchases of the content to a number of active users.

48. The computer-readable medium of claim 41, having further computer-executable instructions for determining the first value and the second value based on a listing penetration of the content and on a member population factor, wherein the member population factor comprises a predetermined numerical value that is associated with a number of active users.

49. The computer-readable medium of claim 48, wherein the member population factor is configured to cause the first and second price to decrease as the number of active users decreases.

50. The computer-readable medium of claim 48, wherein the member population factor is configured to cause the first and second price to increase as the number of active users increases.
